(19) United States
(12) Patent Application Publication
(10) Pub. No.: US 2014/0064832 A1
(43) Pub. Date: Mar. 6, 2014

(54) WELDING STUD HAVING A VARIABLE, HEAD-SIDE FUNCTIONAL REGION

(71) Applicants: Dietmar Rotheut, Eschweiler (DE); Gerald Kuehn, Pulheim (DE)

(72) Inventors: Dietmar Rotheut, Eschweiler (DE); Gerald Kuehn, Pulheim (DE)

(73) Assignee: Ford Global Technologies, LLC, Dearborn, MI (US)

(21) Appl. No.: 14/004,588

(22) PCT Filed: Apr. 24, 2012
(86) PCT No.: PCT/EP12/57424

§ 371 Date: Sep. 11, 2013

(30) Foreign Application Priority Data
May 23, 2011 (DE) 102011076261.2

(51) Int. Cl. B23K 9/20

(52) U.S. Cl. CPC B23K 9/20
USPC 403/270

(57) ABSTRACT

What is proposed is a weld-on element which has a weld-on end and a functional region arranged at a distance from the latter and in which a body which is designed as a welding stud is arranged between the weld-on end and the functional region.

The present invention relates to a weld-on element which has a weld-on end and a functional region arranged at a distance from the latter.

Weld-on elements can be butt-welded to counterpieces, for example metal sheets, for example by what is known as arc welding, so that the weld-on elements project with their functional region from the counterpieces and can therefore hold various structural parts or components. In motor vehicle construction, for example, the weld-on elements can be placed, flush, with their weld-on end onto a body sheet or the like, can be welded to this and can be designed on their functional region such as to afford many different possibilities for holding various structural parts or components. A functional portion of each weld-on element is in this case designed variable, that is to say so as to be adapted correspondingly to the component to be held in each case. For example, cable harnesses, individual cables, lines, hoses or the like can be held on the functional region, and the functional region may also be used for holding trims. The functional region can to that extent be executed in many different ways.

The arc welding method employed may be what is known as stroke ignition welding, as described, for example, in DE 199 25 628 A1.

The WELDFAST® welding method is also known, in which weld-on elements, that is to say WELDFAST® holders, as they are known, are welded to a sheet by means of the arc welding method. The WELDFAST® holders have the weld-on end and the functional region. However, it must be considered a disadvantage in the WELDFAST® holders that they have an elongate form at their weld-on ends, so as to produce virtually a weld-on edge having a long extent. So that these weld-on elements can be welded to a sheet, a special welding appliance is therefore required, which is designed such that the elongate weld-on edge can be welded reliably. However, it is possible that the welded-on weld-on element suffers from welding defects when it is welded, and therefore the required strength parameters cannot be achieved, while, even during the necessary test methods, the weld-on elements possibly fail to withstand the test conditions. It can also easily be imagined that the necessary welding parameters vary considerably on account of the elongate welding edge, thus making cost-effective production difficult, since the welding parameters would always have to be laid down and checked anew. Use of protective gas intended for protecting the surrounding welding region against oxidation also has the effect of increasing the costs. For this purpose, a welding apparatus adapted to the WELDFAST® method has a protective gas bell which restricts free space.

Against this background, the set object of the present invention is to provide a weld-on element with a functional portion, which weld-on element can always be welded reliably, is simpler to handle with regard to the welding parameters and can also be welded cost-effectively.

This object is achieved by means of a weld-on element having the features of claim 1. Further, especially advantageous refinements of the invention are disclosed in the subclaims.

It should be pointed out that the features listed individually in the claims may be combined with one another in any technically expedient way and indicate further refinements of the invention. The description additionally characterizes and specifies the invention particularly in conjunction with the figures.

According to the invention, a weld-on element which has a weld-on end and a functional region arranged at a distance from the latter is provided, said weld-on element having a body which is arranged between the weld-on end and the functional region and which is designed as a welding stud.

Advantageously, the welding stud is a body made from a weldable material, preferably from a weldable metal, which body may have at its weld-on end a flange-like widening which projects beyond a stud shank, as seen in the radial direction, and which stud shank has, opposite the weld-on end, a head region. According to the invention, the functional region is arranged on the head region of the stud shank.

In a beneficial refinement, the body, that is to say the welding stud, is designed as a solid body, so that it can be welded with its weld-on end to a counterpiece, that is to say, for example, to a body sheet, reliably, as compared with placed-on edge welding. It is also conceivable, however, to design the body, that is to say the welding stud, as a hollow body which is closed at its weld-on end.

It is conducive to the object that, according to the invention, the effective welding area is reduced with respect to the elongate welding edge which is sometimes formed with changes in direction. It is possible that the body, that is to say the welding stud, has a planar form at its weld-on end. In a further refinement, the weld-on end may have an ignition tip. There may preferably be provision for the weld-on end of the body, that is to say of the welding stud, to have virtually a form resembling a mushroom head, as seen in section, the weld-on end being designed in the manner of a segment of a circle, as seen in section, with the result that the effective welding area is advantageously reduced with respect to edge welding. What is thus achieved is that the basic material, that is to say the counterpiece, to which the weld-on element is welded, is acted upon only by the action of such heat that, with sufficient penetration welding, a harmful melting of, for example, a welding edge through the relatively thin basic material (metal sheet) can be avoided. Advantageously, use of protective gas may also be dispensed with, as has come to light during sample weldings, the welded joints made having conformed to the test requirements, but even to the requirements laid down in various standards. This has an advantageous effect in that a protective gas bell, which enlarges a space necessary for the welding process and to be kept free, may be dispensed with. If no protective gas bell is required, a component design engineer has substantially more design freedom, since the space to be kept free for the welding process is reduced.

Basically, the weld-on element according to the invention is easier to handle with its weld-on end, as compared with a weld-on edge of elongate form which may also have bends or changes in direction, particularly also because a special welding apparatus has had to be used hitherto which was adapted to the specially designed weld-on element in terms of the elongate configuration of its weld-on end.

It is beneficial if the functional region is arranged on the head region of the body. In one possible refinement, the functional region may be connected or become connected as a separate structural part to the head region. Conceivable materials for the functional region are, for example, plastics. In preferred refinements, there may be provision for producing the functional region and the body, that is to say the welding stud, in one piece, so that a special type of connection of the functional region to the body, that is to say to the welding stud, may be dispensed with. In an especially beneficial refinement, there may be provision for producing the weld-on element according to the invention from a basic material, for example for stamping it out from a sheet metal strip, so that a one-piece stamping with a weld-on end, welding stud and functional region is formed. The stamping could then be machined further, in order to obtain a desired shape of the welding stud and a desired configuration of the functional region. It is also conceivable, however, to form the weld-on element from individual bars or from bar material, with the body, that is to say the welding stud, but also the functional region, being machineable according to the respective configuration which is most advantageous for use.

It is possible for the body, that is to say the welding stud, to have, as seen in cross section, a round or angular, for example square, triangular, etc., form, in which case the weld-on end may have, for example, the configuration resembling a mushroom head. In this refinement, the welding stud projects beyond the preferably sheet-like functional region. It is conceivable to lead the body, that is to say the welding stud, oriented from its weld-on end toward the functional region, in terms of its material thickness, even down to the material thickness of the functional region, so as to form virtually a body tapering in the direction of the functional region. It is possible to produce the welding stud with a portion having the same material thickness, such as the functional region, in which case this portion could be led as far as the weld-on end which projects with its flange-like widening beyond the respective portion, with, as already mentioned, the weld-on end being able to be designed in the manner of a mushroom head.

It is conceivable in this case to form the functional region, for example, with a round or angular circumference, without restricting the circumferential configuration to those mentioned, the functional region being capable of being designed so as to be adapted to the most diverse possible intended uses. For example, the functional region could have a bore with an internal thread, for example in order to hold other components to the body sheet via the weld-on element according to the invention by means of screw connections. It is also conceivable to design the functional region for the purpose of holding cables, hoses, lines or the like, although the examples mentioned are not intended to disclose limits to use. On the contrary, the functional region can be designed for all conceivable and expedient holding purposes or connecting purposes.

It is advantageous that the body, that is to say the welding stud, can be produced so as to be markedly thicker than the functional region. In a preferred refinement, the functional region can be machined such that it has a necessary wall thickness which is adapted to the respective holding task. In other words, the functional region can be designed in terms of its material thickness according to the intended use. It is also beneficial that the body, that is to say the welding stud, can be produced separately from the configuration of the functional region, in which case refinements can be achieved which are especially advantageous in terms of weldability. For example, the welding stud can have an enlarged welding area at its weld-on end, and this may have a positive effect upon the welding process.

It is also especially advantageous that the weld-on element according to the invention can also be welded to thin sheets or such like thin material, without the risk of melt-through, as observed on planar material, for example in the case of elongate welding edges. According to the invention, thin material has a thickness of 0.75 mm or less, but of course may also be somewhat thicker. Thus, by means of the weld-on element according to the invention, the quality of welding or of arc welding, but also its repeatability, is improved considerably, as compared with elongate edge welding on planar material.

Further advantageous particulars and effects of the invention are explained in more detail below by means of an exemplary embodiment illustrated in the figures in which:

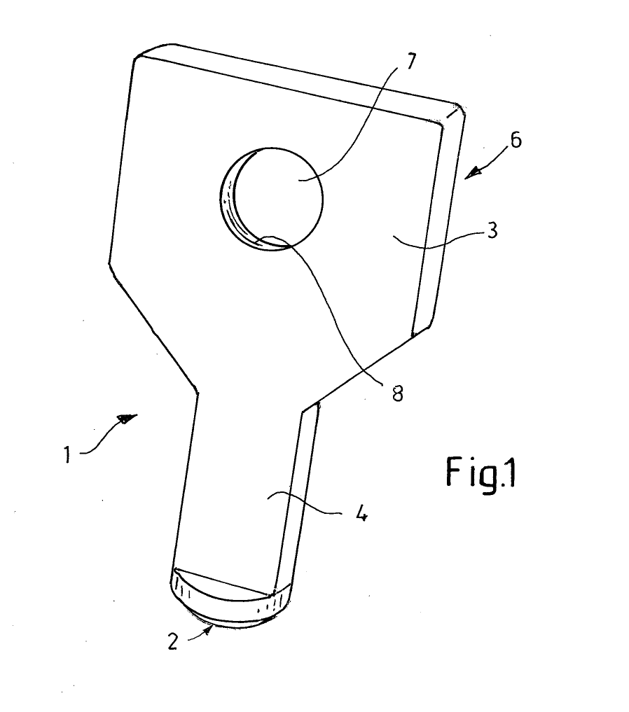

FIG. 1 shows by way of example a weld-on element in a perspective view,

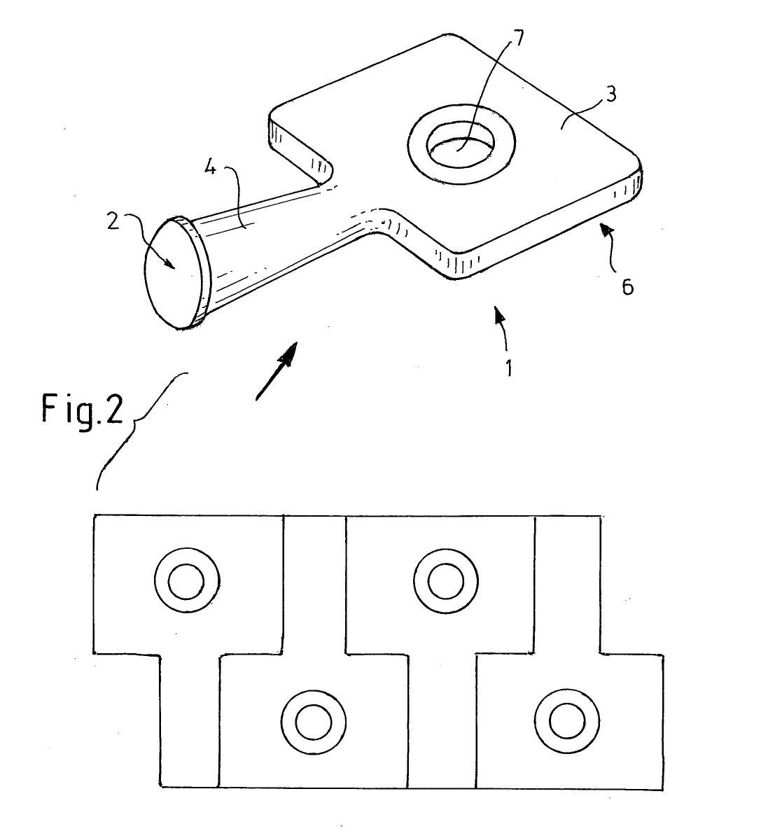

FIG. 2 shows a weld-on element in a second embodiment and its production from a sheet metal strip,

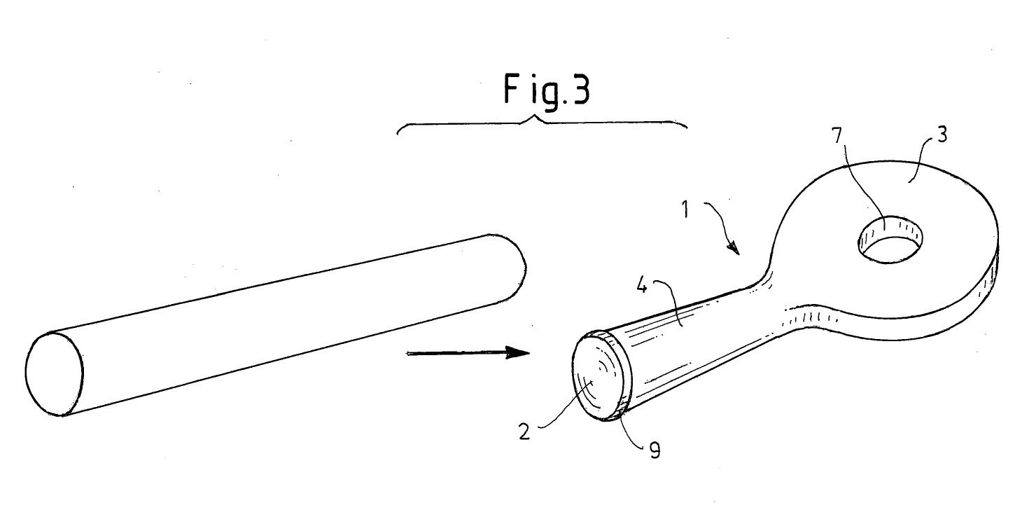

FIG. 3 shows a weld-on element in a further embodiment and its production from a bar material,

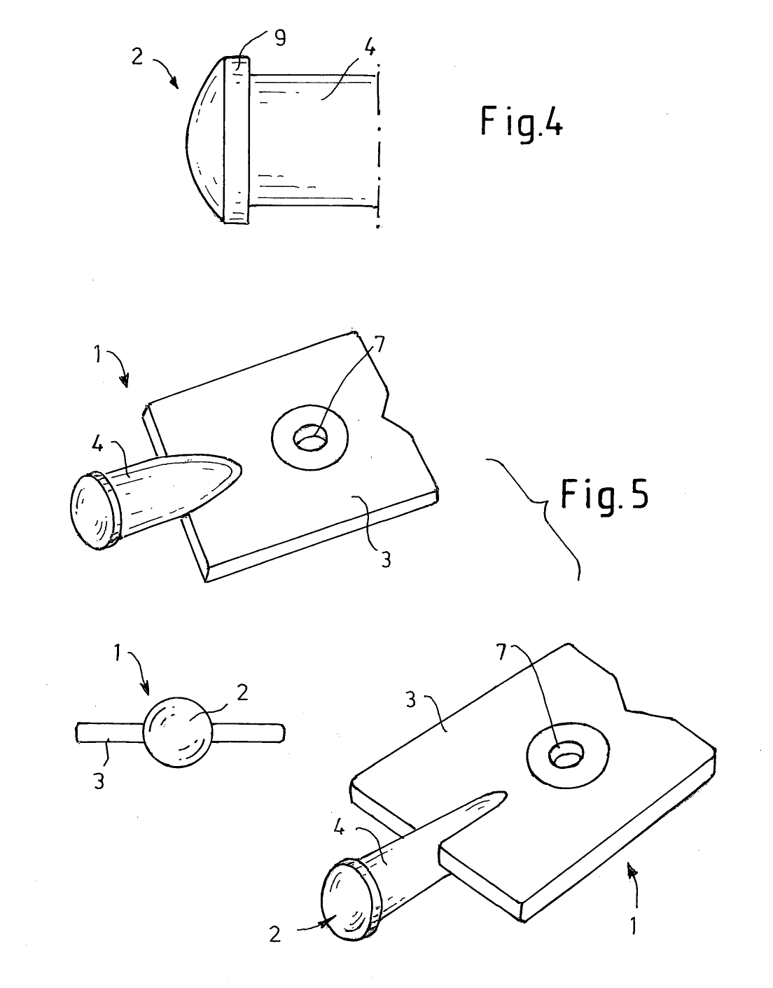

FIG. 4 shows an enlarged illustration of the weld-on end in a side view, and

FIG. 5 shows a weld-on element in a further embodiment in various views.

Identical parts are always given the same reference symbols in the various figures and are therefore usually also only described once.

FIG. 1 shows a weld-on element 1 which has a weld-on end 2 and a functional region 3 arranged at a distance from the latter. Arranged between the weld-on end 2 and the functional region 3 is a body 4 which is designed as a welding stud 4.

The weld-on element 1 can be welded to a counterpiece, for example to a body sheet, by means of arc welding methods, with the most diverse possible components being able to be held on the functional region 3.

In the exemplary embodiment shown in FIG. 1, the body 4 has a square configuration. A round version or triangular version of the body 4 is, of course, also conceivable, without the exemplary embodiments mentioned having any restrictive effect. As may be gathered from FIG. 1, the welding stud 4 has the same material thickness as the functional region 3. The weld-on end 2 is of circular form, FIG. 1 indicating a weld-on end 2 which resembles a mushroom head and which can be seen more clearly in FIG. 4.

In the exemplary embodiment illustrated in FIG. 1, the functional region 3 has a polygonal basic body 6 which has in the middle a bore 7 with an internal thread 8. The bore 7 with the internal thread 8 may serve for screwing a component thereto. Other versions of the functional region 3 may, of course, also be provided, so that the most diverse possible components can be held by the functional region 3. The functional region 3 can be designed such that the most diverse possible components can be directly held on or connected to the functional region (3), for example without auxiliary elements being interposed.

In FIG. 1, the functional region 3 extends in the plane of the body 4 or of the welding stud 4. An angled arrangement of the functional region 3 with respect to the welding stud 4 is also conceivable.

It is advantageous that the weld-on element 1 can be produced in one piece. It is indicated in FIG. 2 that the weld-on element 1 can be stamped out from a rectangular sheet metal strip (at the bottom in FIG. 2). The body 4, that is to say the welding stud 4, in this case has in the first place a polygonal or square basic body which has been formed into a round basic body by shaping. The functional region 3 likewise has a polygonal or square basic body which, for the sake of simplicity, has in the middle merely the bore 7 previously mentioned by way of example.

In the exemplary embodiment illustrated in FIG. 3, the weld-on element 1 is formed from a round bar material. The functional region 3, after machining, has a round basic body with a bore 7 introduced. It is indicated in FIG. 3 that the functional region 3 is set at an angle to the welding stud 4. The body 4 or welding stud 4 has a round form at its weld-on end 2, the welding stud 4 being designed, oriented in the direction of the functional region 3, to taper virtually in a wedge-shaped manner toward the functional region 3. Instead of the angular configuration of the wedge, as illustrated in FIG. 3, a round version may, of course, also be provided.

FIG. 4 shows a preferred refinement of the weld-on end 2 in an enlarged illustration. What can be seen is a flange-like widening 9, which has adjoining it the configuration in the manner of a segment of a circle, so as to form virtually a weld-on end 2 which resembles a mushroom head which is domed so as to be oriented away from the welding stud 4. The weld-on end 2 may, of course, also be of planar form, as indicated in FIG. 2, and/or have an ignition tip which is not illustrated, although the configuration resembling a segment of a circle could also be considered as a rounded ignition tip.

FIG. 5 shows an embodiment, similar to FIG. 3, of the weld-on element 1, particularly with regard to the welding stud 4. The welding stud 4 according to FIG. 5 has a weld-on end 2 of oval form, the welding stud tapering in the direction of the functional region 3. The welding stud does not, of course, have to be led to the material thickness of the functional region 3. It is also conceivable that the edges of the welding stud 4 project above the surface of the functional region 3. The notch which can be seen on the functional region in FIG. 5 is merely of an exemplary nature and is intended to indicate further possibilities for the configuration of the functional region 3, for example with regard to weight savings.

It is conducive to the object that the weld-on end 2 is thicker than the functional region 3, as can be seen in the middle illustration of FIG. 5.

There are basically no limits placed upon the design engineer of the weld-on element 1 with regard to its different configuration, even if only a few exemplary embodiments are described and can be seen in FIGS. 1 to 5. The body 4, that is to say the welding stud 4, may be designed in terms of its configuration separately from the execution of the functional region 3, for example in terms of static needs and/or welding requirements. The functional region 3 will be formed separately therefrom preferably with regard to the respective intended use.

It is conducive to the object of the invention that, on account of the arrangement of the welding stud 4 between the weld-on end 2 and the functional region 3, the weld-on element 1 according to the invention can be welded to the corresponding counterpiece, that is to say, for example, to a vehicle body, by means of a simple stud welding method, while a protective gas bell restricting free space or the use of protective gas itself may be dispensed with during the welding process, as has been confirmed by sample weldings. The functional region 3 can in this case be designed to be adaptable in a versatile way to the respective holding task.

A weld-on element 1 which can be handled easily by means of the stud welding method and which can be welded without any complication and cost-effectively is to that extent provided.

1. A weld-on element, which has a weld-on end and a functional region arranged at a distance from the latter, wherein a body which is designed as a welding stud is arranged between the weld-on end and the functional region.

2. The weld-on element as claimed in claim 1, wherein the body is formed from a weldable material comprising a weldable metal.

3. The weld-on element as claimed in claim 1, wherein the body has a flange-like widening at the weld-on end.

4. The weld-on element as claimed in claim 1, wherein the functional region is arranged on a head region, arranged opposite the weld-on end, of the body.

5. The weld-on element as claimed in claim 1, wherein the body is designed as a solid body.

6. The weld-on element as claimed in claim 1, wherein the weld-on end is designed in the manner of a segment of a circle, so that a weld-on end resembling a mushroom head is formed.

7. The weld-on element as claimed in claim 1, wherein the weld-on element is formed in one piece from a basic material.

8. The weld-on element as claimed in claim 1, wherein the weld-on element is stamped in one piece out of a sheet metal material.

9. The weld-on element as claimed in claim 1, wherein the weld-on element is formed in one piece from a bar material.

10. A weld-on element comprising:
a weld-on end;
a functional region arranged at a distance from the weld-on end; and
a welding stud arranged between the weld-on end and the functional region.

11. The weld-on element as claimed in claim 10, wherein the welding stud is formed from a weldable material comprising a weldable metal.

12. The weld-on element as claimed in claim 10, wherein the welding stud has a flange-like widening at the weld-on end.

13. The weld-on element as claimed in claim 10, wherein the functional region is arranged on a head region, arranged opposite the weld-on end, of the welding stud.

14. The weld-on element as claimed in claim 10, wherein the welding stud is designed as a solid body.

15. The weld-on element as claimed in claim 10, wherein the weld-on end is designed in the manner of a segment of a circle, so that a weld-on end resembling a mushroom head is formed.

16. The weld-on element as claimed in claim 10, wherein the weld-on element is formed in one piece from a basic material.

17. The weld-on element as claimed in claim 10, wherein weld-on element is stamped in one piece out of a sheet metal material.

18. The weld-on element as claimed in claim 10, wherein the weld-on element is formed in one piece from a bar material.
